(19) United States
(12) Patent Application Publication
(10) Pub. No.: US 2011/0319005 A1
(43) Pub. Date: Dec. 29, 2011

(54) DAMPER PLATE

(76) Inventors: Koji Sawada, Aichi-ken (JP); Masaaki Yamamoto, Aichi-ken (JP); Yoshimitsu Hibino, Aichi-ken (JP)

(21) Appl. No.: 12/998,122

(22) PCT Filed: Jun. 25, 2010
(86) PCT No.: PCT/JP2010/060821

§ 371 Date: Mar. 18, 2011

(51) Int. Cl. B60H 1/34

(52) U.S. Cl. 454/155

(57) ABSTRACT

Peripheral ribs 34A, 34B of a damper plate 30 are raised from at least two sides along an extending direction of a rotation shaft 31 among four sides forming the peripheral portion of the damper plate 30 and have belt-like outer surfaces. When the damper plate 30 is positioned at a position to close a ventilation path 40, the outer surface of the upper peripheral rib 34A becomes parallel with an upper wall surface 13A of the retainer with a narrow clearance therebetween and the outer surface of the lower peripheral rib 34B becomes parallel with a lower wall surface 13B of the retainer with a narrow clearance therebetween.

### TECHNICAL FIELD

The present invention relates to a damper plate which is rotatably arranged in a ventilation path formed in a retainer of a register utilized for air conditioning in a vehicle and opens/closes the ventilation path. Further, the present invention relates to a register in which the damper plate is arranged.

### BACKGROUND ART

Conventionally, there are reported various technologies concerning a damper to improve sealing property when closing a ventilation path, the damper being rotatably arranged in the ventilation path formed in a retainer of a register for air conditioning in a vehicle.

For example, the damper disclosed in patent documents 1 and 2 is constructed with two elements, that is, a rectangular damper plate having bifurcate grasping edges formed around four sides thereof and a damper seal made of soft rubber such as urethane or soft synthetic resin, the damper seal being formed in a ring shape and resiliently set to the grasping edges of the damper plate.

When the damper disclosed in patent documents 1 and 2 rotates and closes the ventilation path, the damper seal contacts with wall surfaces of the ventilation path, thereby wind-flow in the ventilation path is almost completely shut out.

On the other hand, in order to obtain sealing property when the ventilation path is closed, the size of the damper with the damper seal is formed slightly larger than the size of the ventilation path. Thereby, when the ventilation path is closed by the damper, the damper seal and the inner walls of the retainer contact with each other. Here, there is a problem that the damper cannot be smoothly rotated or allophone occurs. In order to dissolve this problem, for instance, in patent document 3, there is disclosed a technology that the damper seal is formed in a size that can avoid contact with the inner walls of the retainer (air outlet 10) when rotating and a rib configured to make contact with the damper seal is formed in the inner wall of the retainer along a complete shut-out position of the damper. Thereby, when the damper closes the ventilation path of the retainer, the damper seal makes contact with the rib, and as a result, sealing property is obtained.

Here, in case of the damper in which the damper seal is provided, as a technology to prevent allophone from occurring due to the contact of the damper seal and the inner wall of the retainer, it is proposed that the damper seal is soaked in silicon oil before assembled to the damper plate.
Patent Document 1: Utility Model Registration Gazette No. 2570855
Patent Document 2: Utility Model Registration Gazette No. 2575479
Patent Document 3: Publication of Unexamined Patent Application No. Hei7-137532

### DISCLOSURE OF THE INVENTION

### Problem to be Solved by the Invention

However, in the technology to improve sealing property by assembling the damper seal to the damper plate, there are problems as follows. First, since the damper is constructed with two elements of the damper plate and the damper seal, cost of the damper seal and man-hour for assembling the damper seal to the damper plate become larger, thus cost of producing the damper increases. In particular, in the damper plate, to form the bifurcate grasping edges to grasp the damper seal, it is necessary to produce a die where a slide process can be conducted. Thereby, cost of producing the die also increases.

In a case that the damper seal is soaked in silicon oil, silicon oil adheres to other elements constructing the register, thus the other elements are polluted by the silicon oil. Further, there is also a problem that quality control of silicon oil is difficult.

As shown in the patent document 3, in a case that the rib is formed on the inner wall, the rib will become an obstruction when the damper is assembled. Also, the shape of the retainer becomes complex, and thereby cost of producing the retainer increases. However, up to now, there is scarcely reported a technology to obtain sealing property without forming a rib on the inner wall of the retainer or making the damper plate contact with the inner wall of the retainer when the ventilation path is closed.

Therefore, the present invention has been made to solve the above problems and the present invention has an object to provide a damper plate by which sealing property of the ventilation path can be obtained without making the damper plate contact with the inner wall of the retainer when the ventilation path is closed, even though a damper seal is not set to the damper plate and a rib is not formed on the inner wall of the retainer.

### Means for Solving the Problem

In order to accomplish the above object, the damper plate according to claim 1 is rotatably arranged in a ventilation path formed within a retainer of a register for air conditioning in a vehicle, the damper plate having a flat plate portion formed in a substantially rectangular shape and a rotation shaft, in which two sides among four sides forming a periphery of the flat plate portion are configured to approach near a pair of inner walls opposing each other in the retainer, thereby the damper plate closes the ventilation path, wherein the damper plate has first peripheral ribs raised so as to form outer surfaces at least from the two sides of the periphery of the flat plate portion, and wherein, when the damper plate is rotated to a position to close the ventilation path, the outer surfaces of the first peripheral ribs formed in the two sides respectively approach to the inner walls of the retainer and respectively become parallel with the inner walls while securing narrow clearances therebetween.

Further, in the damper plate of claim 2 according to claim 1, a second peripheral rib is formed in each of the two sides, the second peripheral rib having a symmetrical shape with a first peripheral rib with respect to a center section of the damper plate, the center section representing a sectional plane passing a rotational center of the rotation shaft and perpendicular to a thickness direction of the damper plate.

In the damper plate of claim 3 according to claim 2, each of the first peripheral ribs in the two sides is raised from an opposite side of the flat plate portion with respect to the center section, and the outer surface of the first peripheral rib intersects the center section at an acute angle.

Further, in the damper plate of claim 4 according to claim 1, each of the first peripheral ribs in the two sides faces to a direction of incoming air when the damper plate is rotated to the position to close the ventilation path.

In the damper plate of claim 5 according to any one of claims 1 to 4, a thinner portion which is thinner than the flat plate portion is formed in the flat plate portion forming a main body of the damper plate along the first peripheral rib.

In the register according to claim 6, the damper plate according to any one of claims 1 to 6 is arranged.

### Effect of the Invention

The first peripheral ribs in the damper plate of claim 1 are raised from at least two sides along an extending direction of the rotation shaft among the four sides forming the periphery of the damper plate and have the outer surfaces. When the damper plate is rotated to the position to close the ventilation path, the outer surfaces of the first peripheral ribs formed in each of the two sides approach to each of the inner walls of the retainer and become parallel with the inner walls with the narrow clearances therebetween. Thereby, when the ventilation path is closed, the plane-like narrow clearances are formed between the outer surfaces of the first peripheral ribs and the inner walls of the retainer. These plane-like narrow clearances provide high resistance for air flowing in the ventilation path of the retainer. As a result, similar to the conventional case that the damper seal is provided with the damper plate, such narrow clearances can stop the flow of the air. Thus, even though the damper seal is not provided with the damper plate or ribs are not formed within the retainer, according to the damper plate of claim 1, the sealing property of the ventilation path can be obtained without bringing the damper into contact with the inner walls of the retainer when the ventilation path is closed. Therefore, the damper plate of claim 1 can solve the problems that allophone occurs and the damper cannot be smoothly rotated, and cost of producing the damper can be drastically reduced.

According to the damper plate of claim 2, the second peripheral rib is formed in each of the two sides, each second peripheral rib having the symmetrical shape with the first peripheral rib with respect to the center section of the damper plate representing the sectional plane passing the rotational center of the rotation shaft and perpendicular to the thickness direction of the damper plate. Such a damper plate works very effectively when, for example, two registers having a symmetrical shape with each other are arranged at a right position and a left position on an instrument panel, respectively. That is, not only the first peripheral rib but also the second peripheral rib is formed on one damper plate. Therefore, when the ventilation path in one register is closed, the sealing property of the ventilation path can be retained by the first peripheral rib. In the other register, the same damper plate is used in a state that the damper plate is reversed. Thus, the sealing property of the ventilation path in the other register can be obtained in a similar manner in one register. Here, in the other register, when the ventilation path is closed, the outer surfaces of the second peripheral ribs become parallel with the inner walls of the retainer with the narrow clearances therebetween. As mentioned, in the damper plate of claim 2, one kind of the damper plate can be utilized in two registers having the symmetrical shape with each other. As a result, it is unnecessary to produce two kinds of damper plates each of which corresponds to each register. Thereby, die producing cost can be further reduced.

In the damper plate of claim 3, each of the first peripheral ribs in the two sides is raised from an opposite side of the flat plate portion with respect to the center section, and the outer surface of the first peripheral rib intersects the center section at an acute angle. Thus, even though the damper plate closes the ventilation path in an inclined state against the inner walls of the retainer without making the damper plate in a state normal to the inner walls, the second peripheral ribs can be formed so as not to disturb rotation of the damper plate.

In the damper plate of claim 4, each of the first peripheral ribs in the two sides faces to a direction of incoming air when the damper plate is rotated to the position to close the ventilation path. Therefore, entrance shape of the narrow clearances formed between the first peripheral ribs and the inner walls of the retainer and parallel with the inner walls makes it harder for the air flowing through the ventilation path to flow thereinto. Thus, the sealing property by the damper plate in the ventilation path can be further effectively improved.

In the damper plate of claim 5, a thinner portion thinner than the flat plate portion is formed in the flat plate portion forming the main body of the damper plate along the first peripheral rib. Here, in rare cases, the peripheral end portions of the damper plate and the inner walls of the retainer interfere with each other due to production variations while rotating the damper plate to close the ventilation path. The impact of the interference can be absorbed through the thinner portion. Therefore, the damper plate can rotate to a state that the damper plate closes the ventilation path.

In the damper plate of claim 6, the first peripheral ribs are formed all around the periphery except for the rotation shaft and the grasped portion in the periphery of the damper plate. Therefore, the outer surfaces of the first peripheral ribs face to a pair of the inner walls of the retainer supporting the rotation shaft of the damper plate with the narrow clearances therebetween. Thus, the sealing property when the ventilation path is closed can be further improved.

### BRIEF DESCRIPTION OF THE DRAWINGS

FIG. 1 is a front view of the register according to the first embodiment.

FIG. 2 is an exploded perspective view of the register according to the first embodiment.

FIG. 3 is an A-A sectional view in FIG. 1.

FIG. 4 is a sectional view obtained by sectioning the register in a state that the ventilation path is closed at A-A position in FIG. 1.

FIG. 5 is a plan view of the damper plate according to the first embodiment.

FIG. 6A is a perspective view of the damper plate according to the first embodiment.

FIG. 6B is a perspective view of the damper plate of the first embodiment when seen from another direction.

FIG. 7A is a side view of the damper plate according to the first embodiment.

FIG. 7B is a side view of the damper plate according to the first embodiment.

FIG. 8 is a front view of the damper plate according to the first embodiment, in which a part of the damper plate is indicated in an enlarged state.

FIG. 9A is a D-D sectional view in FIG. 5.

FIG. 9B is an E-E sectional view in FIG. 5.

FIG. 10 is a B-B sectional view in FIG. 1.

FIG. 11 is a rear view of the register according to the first embodiment.

FIG. 12 is a C-C sectional view in FIG. 1.

FIG. 13 is a sectional view obtained by sectioning the register in a state that the ventilation path is closed at a C-C position in FIG. 1, in which a part of the register is indicated in an enlarged state.

FIG. 14 is a plan view of the damper plate according to the second embodiment.

FIG. 15A is a perspective view of the damper plate according to the second embodiment.

FIG. 15B is a perspective view of the damper plate of the second embodiment when seen from another direction.

FIG. 16 is an F-F sectional view in FIG. 14.

FIG. 17A is a side view of the damper plate of the second embodiment.

FIG. 17B is a side view of the damper plate of the second embodiment when seen from another side.

FIG. 18 is a sectional view obtained by sectioning the register in which the damper plate of the second embodiment is arranged and the ventilation path is open, at the C-C position in FIG. 1.

FIG. 19 is a sectional view obtained by sectioning the register in which the damper plate of the second embodiment is arranged and the ventilation path is closed, at the C-C position in FIG. 1, in which a part of the resister is indicated in an enlarged state.

FIG. 20 is a plan view of the damper plate according to the third embodiment.

FIG. 21A is a G-G sectional view in FIG. 20.

FIG. 21B is an H-H sectional view in FIG. 20.

FIG. 22A is a side view of the damper plate.

FIG. 22B is a side view of the damper plate when seen from another side.

FIG. 23 is a sectional view obtained by sectioning the register in which the damper plate of the third embodiment is arranged and the ventilation path is open, at the C-C position in FIG. 1.

FIG. 24 is a sectional view obtained by sectioning the register in which the damper plate of the third embodiment is arranged and the ventilation path is closed, at the C-C position in FIG. 1, in which a part of the resister is indicated in an enlarged state.

FIG. 25 is a perspective view of the damper plate according to the fourth embodiment.

FIG. 26 is a sectional view obtained by sectioning the damper plate of the fourth embodiment at a D-D position in FIG. 5.

### EXPLANATION OF REFERENCES

1 register
13 retainer
13A upper wall surface of retainer
13B lower wall surface of retainer
34A, 34A, 34B, 34B, 134C, 134D, 234E, 234F peripheral rib
30, 130, 230, 330 damper plate
31 rotation shaft
32 grasped portion
35, 135, 235 center line
40 ventilation path
36, 136, 236, 336 plate portion
350 thinner portion

### BEST MODE FOR CARRYING OUT THE INVENTION

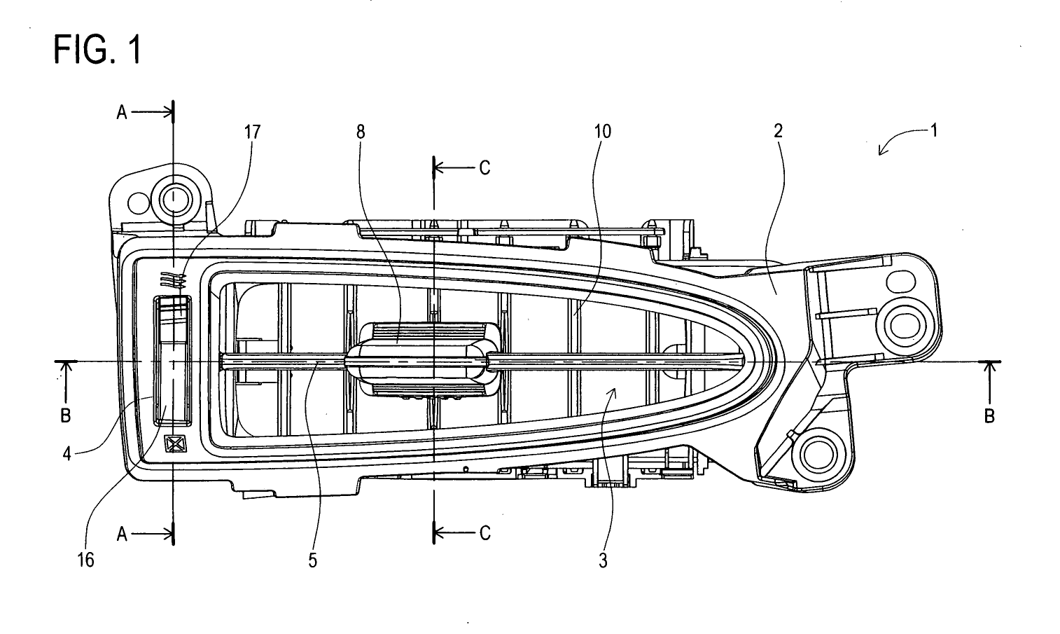

Hereinafter, the damper plate according to the present invention will be described in detail with reference to FIGS. 1-26 based on four embodiments embodying the present invention.

First, based on FIGS. 1-3, the register 1, in which any of the damper plates according to four embodiments can be arranged, will be described. Here, the left side in FIG. 1 is defined as the left direction of the register 1, the right side of FIG. 1 is defined as the right direction of the register 1, the lower side in FIG. 1 is defined as the lower direction of the register 1, the upper side of FIG. 1 is defined as the upper direction of the register 1, the front side in FIG. 1 is defined as the front direction of the register and the rear side in FIG. 1 is defined as the rear direction of the register 1.

The register 1 is used, as a pair, with a symmetric register and arranged with the symmetric register at symmetric positions on an instrument panel of a vehicle, respectively.

As shown in FIGS. 1 to 3, the register 1 according to the first embodiment has a bezel 2 forming a front portion of the register 1 and a retainer 13 formed in a duct shape, to which the bezel 2 is inlayed and connected.

As shown in FIG. 1, in front view, the bezel 2 has a shape elongated in the length direction and shortened in the width direction and is provided with a blow opening 3 having a substantially narrow isosceles triangle shape.

In the blow opening 3, one front fin 5 is pivotally supported along a center line of the isosceles triangle. At the rear side, rear fins 10, which are pivotally supported by rotation shafts substantially perpendicular to a rotation shaft of the front fin 5, are arranged. In FIG. 1, the front fin 5 changes wind direction in up and down directions and the rear fins 10 change wind direction in right and left directions. Here, in FIG. 1, both the front fin 5 and the rear fins 10 are in a state that the front fin 5 and the rear fins 10 are rotated so as to fully open the blow opening 3.

At the left side of the blow opening 3, a dial opening 4 is formed and a dial 16 having a circular shape in a side view thereof is rotatably inserted in the dial opening 4 from the rear side of the bezel 2. An operator can open/close a ventilation path 40 to be described hereinafter by operating a dial knob 17 of the dial 16 in up and down directions.

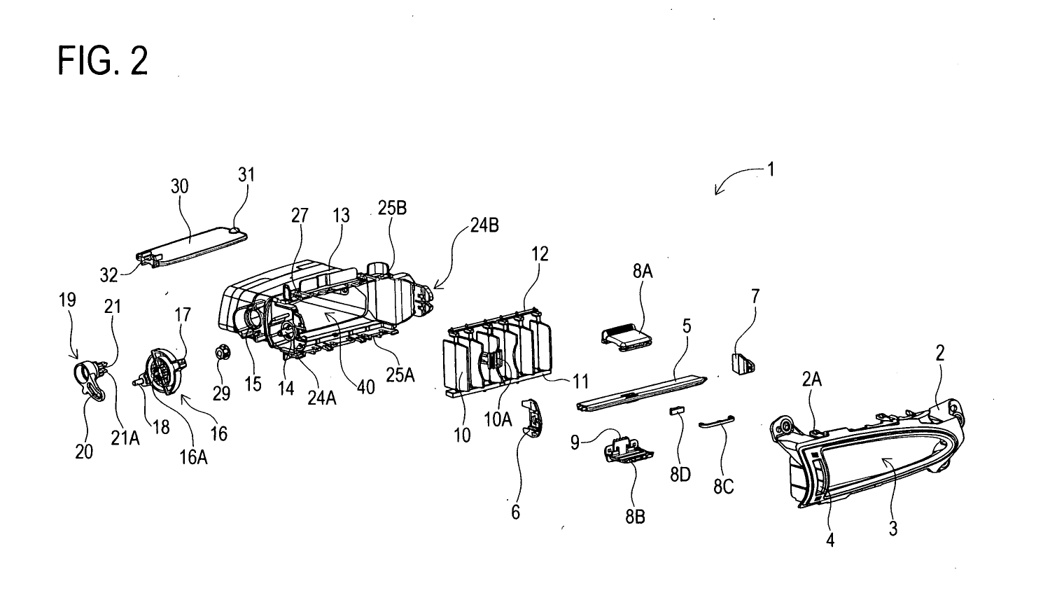

As shown in FIG. 2, the front fin 5 has a pair of rotation shafts formed at both ends thereof and the pair of rotation shafts are rotatably supported in a left bearing member 6 and a right bearing member 7. An operation knob 8 is outwardly arranged along a length direction of the front fin 5 in a movable manner in up and down directions, so as to put substantially central portion of the front fin 5 therebetween. The operation knob 8 is constructed with an upper member 8A, a lower member 8B, a metallic member 8C and an inner fitting member 8D. After these members 8A through 8D are assembled to the front fin 5, rack teeth 9 formed on the lower member 8B are arranged at a rear side of the front fin 5.

Each of the plurality of rear fins 10 has a lower rotation shaft which is rotatably supported in a bearing plate 11. Further, in each rear fin 10, a protrusion is extended rearward from an upper rotation shaft and each protrusion is connected with a connection plate 12. Thereby, the rear fins 10 are rotated all together and rotation angle of the rear fins 10 can be changed at one time. At one rear fin 10 among the plural rear fins 10, a fan-shaped gear 10A is arranged so as to protrude forward. This fan-shaped gear 10A is provided so as to mesh with the rack teeth 9 of the lower member 8B constructing the operation knob 8 arranged on the front fin 5. Therefore, when the operation knob 8 is operated in a sliding manner in right and left directions along the front fin 5, the rotation angle of the rear fins 10 can be changed at one time because the rear fins 10 are rotated all together.

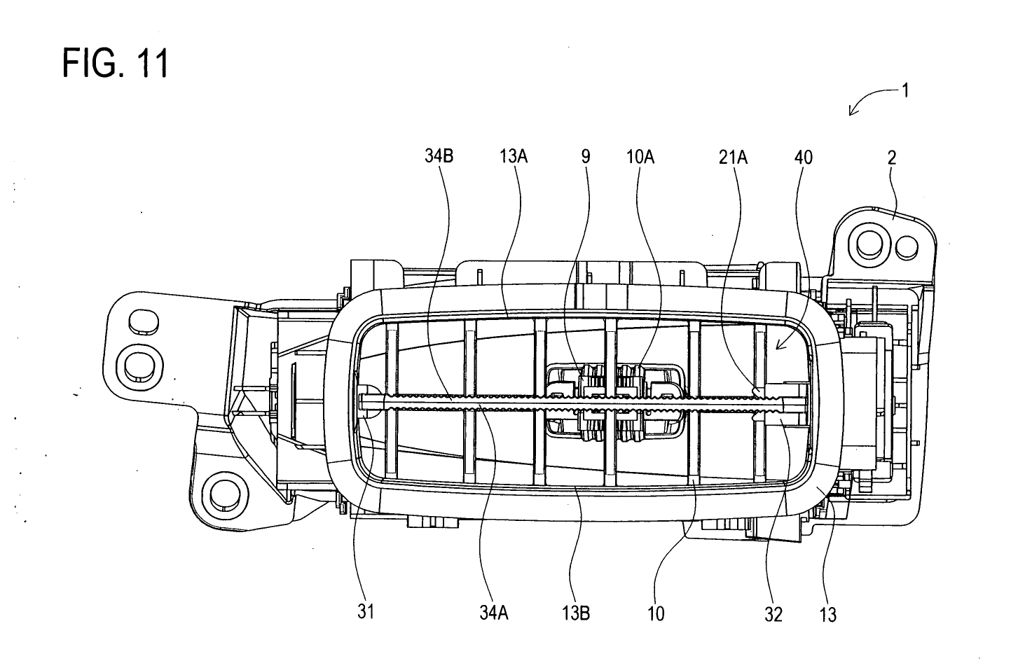

Within the retainer 13 with a duct shape, a ventilation path 40 having a substantially rectangular shape when seen from the rear side (see FIG. 11) is formed and the retainer 13 has an engagement portion 27 on the outer wall. The engagement portion 27 is engaged with an engagement hole 2A formed in the bezel 2, thereby the bezel 2 and the retainer 13 are combined. In a state that the bezel 2 and the retainer 13 are combined, the blow opening 3 and the ventilation path 40 are connected together. Here, the left bearing member 6 and the right bearing member 7 receiving the rotation shafts of the front fin 5 are arranged on the inner sides of a left receiving portion 24A and a right receiving portion 24B of the retainer 13, respectively. The bearing plate 11 receiving the rotation shafts of the rear fins 10 is arranged on the inner side of a lower receiving portion 11 of the retainer 13 and the upper rotation shafts of the rear fins 10 are arranged within holes 25B formed on an upper wall of the retainer 13. When the bezel 2 is combined with the retainer 13, the left bearing member 6, the right bearing member 7, the bearing plate 11 and the upper rotation shafts of the rear fins 10 are firmly fixed between the right and left inner walls, the upper and lower rear end portions of the bezel 2 and the retainer 13.

In the register 1, a damper plate 30 (described hereinafter) rotatably supported by the right and left inner walls of the retainer 13, the dial 16 mentioned above and a grasping member 19 to grasp the damper plate 30 are provided. The dial 16 has a circular shape in side view and a shaft 18 is protruded from the side wall of the dial 16 at a position opposite to the dial knob 17. The damper plate 30 (mentioned hereinafter) has a rotation shaft 31 protruded outward from one end in the length direction of the damper plate 30 and a grasped portion 32 formed at the other end in the length direction of the damper plate 30. The grasping member 19 has a bifurcate portion 21 into which the grasped portion 32 of the damper plate 30 is put and a guide groove 20 with a long hole shape.

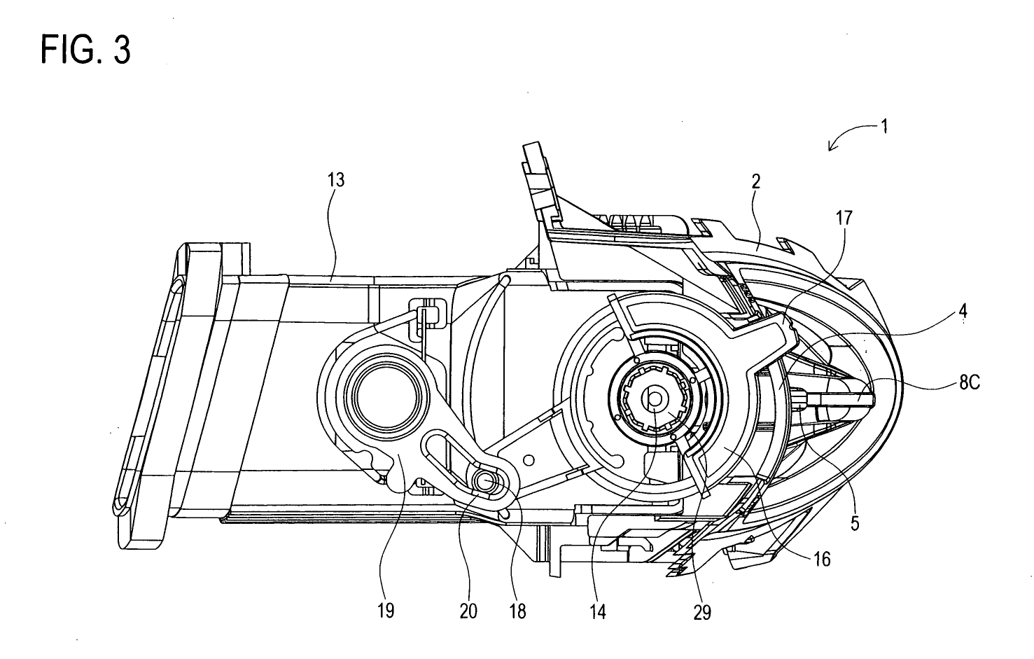

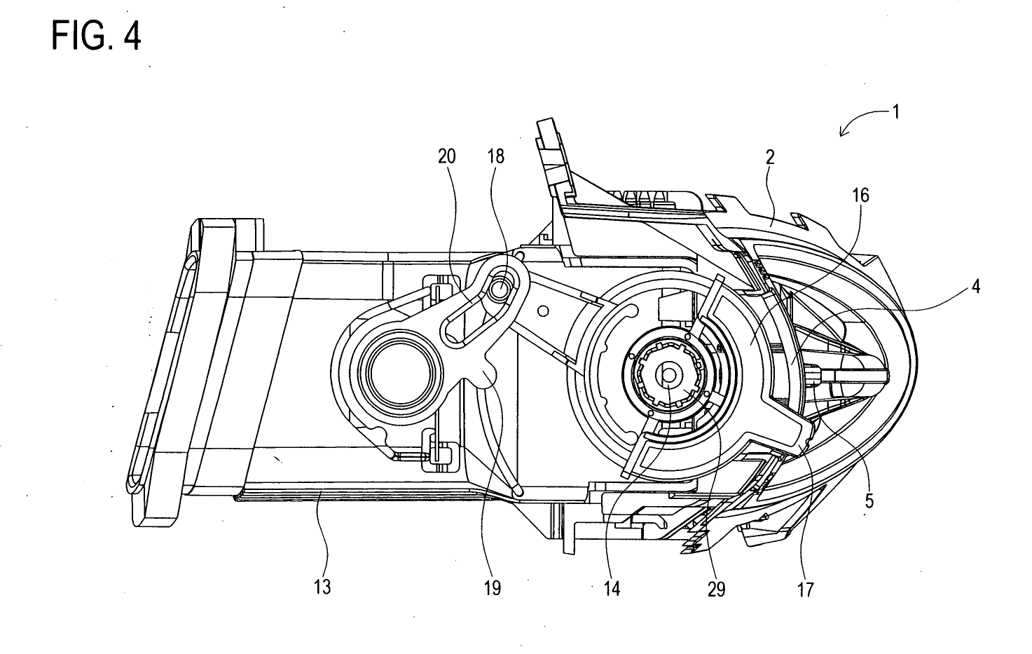

In the retainer 13, a dial shaft 14 is protruded from the left outer wall surface and an insertion hole 15 is formed. As shown in FIGS. 3 and 4, the dial shaft 14 of the retainer 13 is inserted in a center hole 16A formed in the dial 16 and the dial 16 is rotatably attached to the retainer 13 by tightening a screw portion formed around the periphery of the center hole 16A through a nut 29. The bifurcate portion 21 of the grasping member 19 is inserted in the insertion hole 15 of the retainer 13; thereby the grasping member 19 grasps the grasped portion 32. Simultaneously, the shaft 18 of the dial 16 is inserted in the guide groove 20 of the grasping member 19; thereby the grasping member 19 and the dial 16 are engaged with each other.

As shown in FIG. 3, when the ventilation path 40 is opened, the dial knob 17 is positioned at the upper end portion of the dial opening 4. At that time, the shaft 18 of the dial 16 is positioned at the lowermost position. As shown in FIG. 4, when the user pushes down the dial knob 17 to the lower end of the dial opening 4, the shaft 18 of the dial 16 is rotated approximately 50 degrees in clockwise direction around the dial shaft 14. Thereby, the arm of the grasping member 19 is lifted up and is rotated approximately 80 degrees in counter-clockwise direction. At the same time, the damper plate 30 grasped by the grasping member 19 is rotated with the same angle in the counter-clockwise direction.

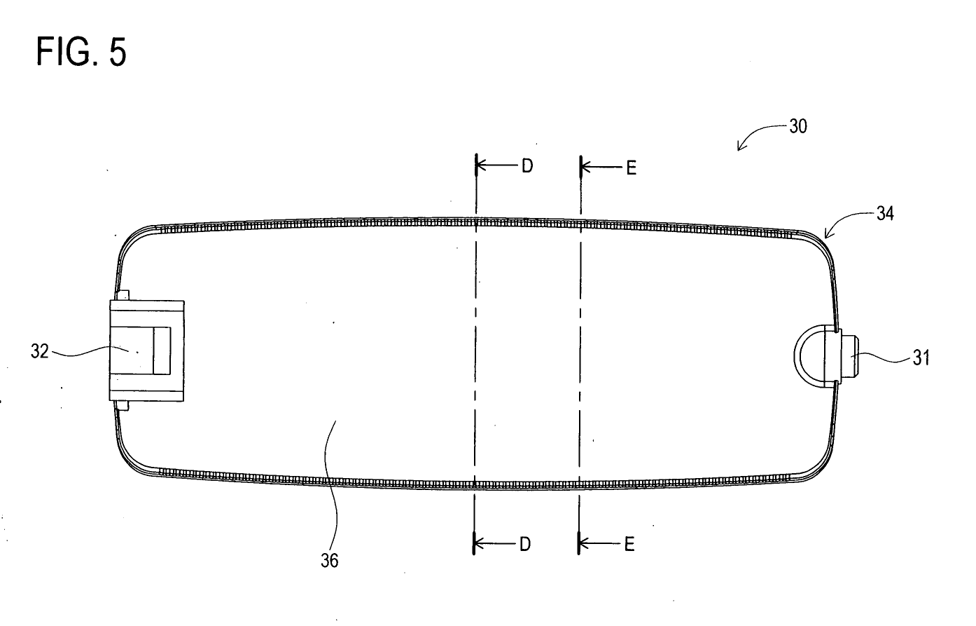

Next, the concrete construction of the damper plate 30 according to the first embodiment will be described in detail with reference to FIGS. 5 to 9. As shown in FIGS. 5 to 7, the damper plate 30 has a substantially rectangular shape in which four corners are formed in round shapes. Peripheral ribs 34 are formed all around a periphery of the damper plate 30 except for the rotation shaft 31 and the grasped portion 32. In the damper plate 30, a center portion except for the rotation shaft 31, the grasped portion 32 and the peripheral ribs 34 forms a flat plate portion 36.

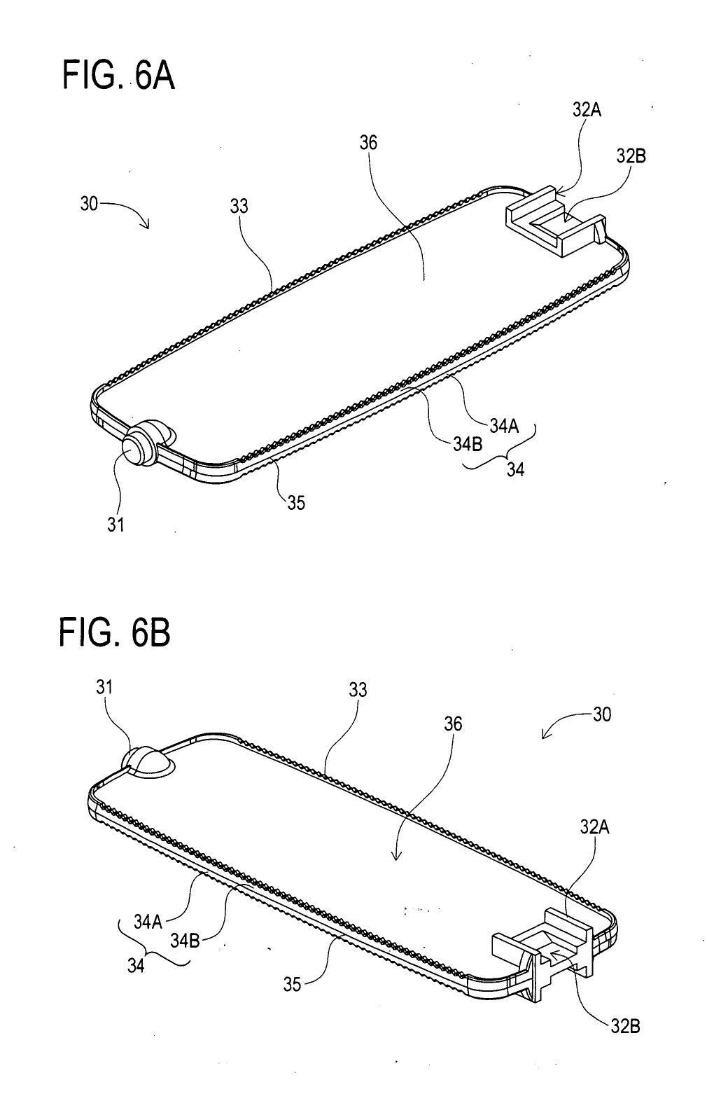

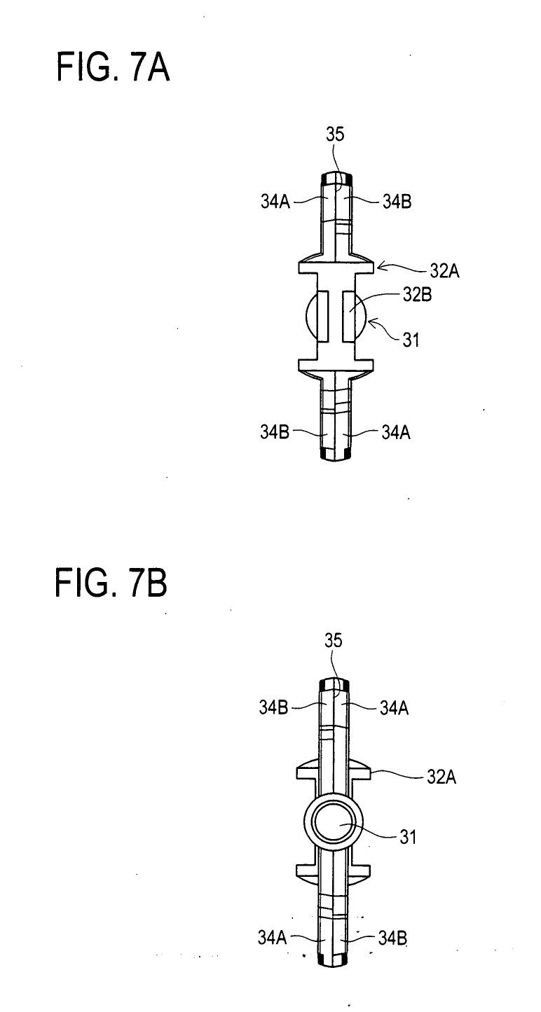

The rotation shaft 31 has a substantially columnar shape. On the other hand, the grasped portion 32, as shown in FIGS. 6B and 7A, is concaved in two-stages and symmetrical with respect to a central sectional plane (line 35 indicates a bisector through which the central sectional plane passes and is referred to as a “center line” hereinafter), which perpendicularly intersects the thickness direction of the damper plate 30 and passes the center of the rotation shaft 31. A bottom plane of an inner concave portion 32B and a bottom plane of an outer concave portion 32A are continued by normal walls in the width direction of the damper plate 30 and continued by a slant wall in the length direction of the damper plate 30. With this shape of the grasped portion 32, the grasped portion 32 can be fit into an inner shape of the bifurcate portion 21 in the grasping member 19. A hook portion 21A formed at each top end of the bifurcate portion 21 (see FIG. 2) is firmly engaged with a difference portion formed by the outer concave portion 32A and the inner concave portion 32B, thereby the bifurcate portion 21 of the grasping member 19 is firmly engaged with the grasped portion 32.

As shown in FIGS. 6A to 73, the peripheral rib 34 is constructed from the peripheral ribs 34A, 34A and the peripheral ribs 34B, 34B (hereinafter, abbreviated as “34A-34B”). One peripheral rib 34A is formed along a semicircle portion formed from the rotation shaft 31 to the grasped portion 32 in the whole periphery and one peripheral rib 34B is formed along the remaining semicircle. Here, the peripheral ribs 34A have the same shape and stand from the opposite sides with respect to the center line 35. Each peripheral rib 34B is formed so as to become symmetrical with each of the peripheral ribs 34A, 34A with respect to the center line 35.

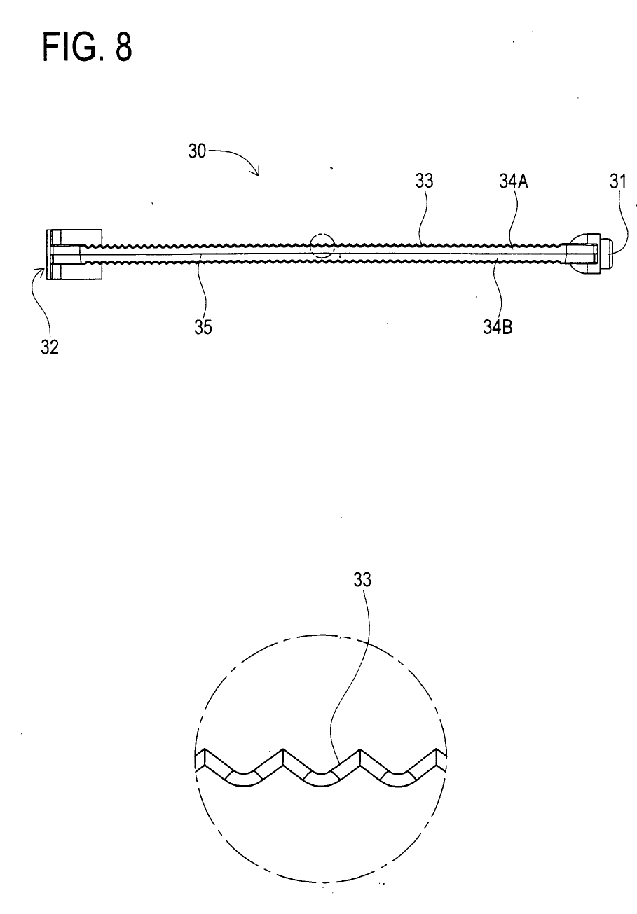

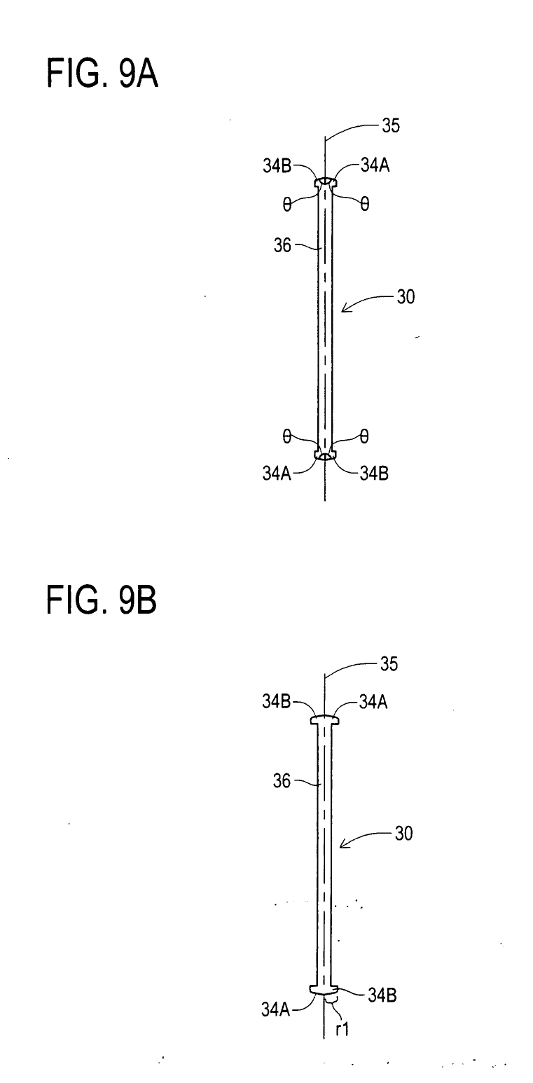

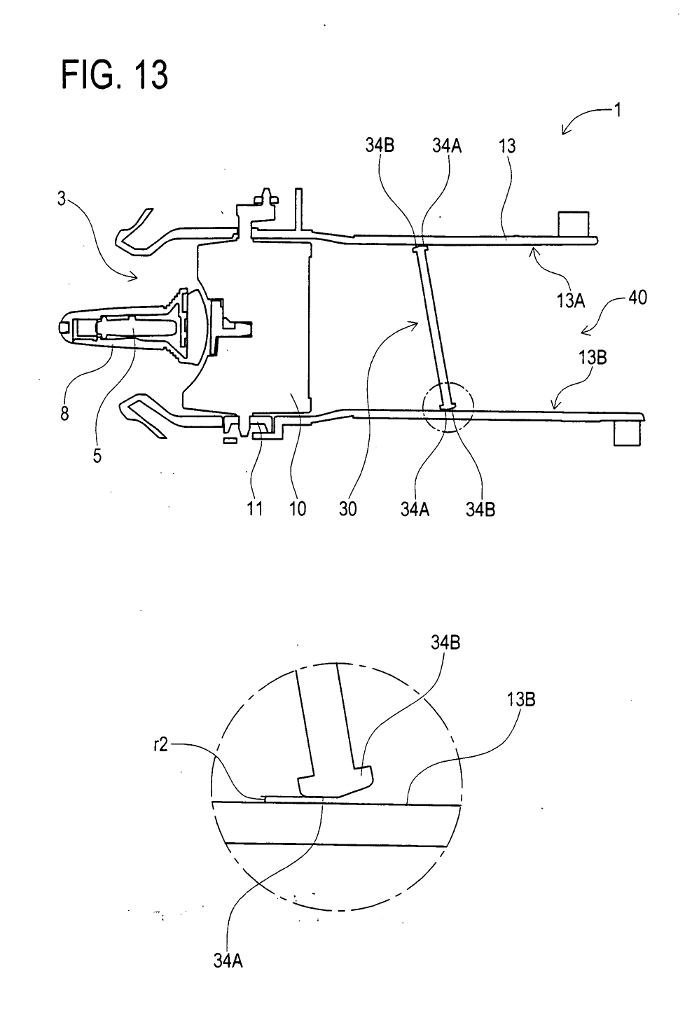

As shown in FIGS. 6 and 8, the outer surface of each of the peripheral ribs 34A-34B substantially normally intersects the center line 35, at the two sides along the width direction. On the other hand, as shown in FIGS. 6 and 9, at the two sides along the length direction, the outer surface of each of the peripheral ribs 34A-34B is inclined with the same inclined angle θ (for example, approximately 80 degrees) so that the top end of each of the peripheral ribs 34A-34B comes closer to the center portion of the damper plate 30. The inclined angle θ, which is formed by the each outer surface of the peripheral ribs 34A, 34A formed along the two sides in the length direction and the center line 35, is substantially equal to the angle (see FIG. 13) formed by the damper plate 30 and the upper and lower wall surfaces 13A, 13B when the ventilation path 40 is closed. Thereby, when the ventilation path 40 is closed, the outer surfaces of the peripheral ribs 34A, 34A and the upper and lower wall surfaces 13A, 13B become parallel.

As clearly shown in FIG. 8, on the top end of each of the peripheral ribs 34A-34B, unevenness portions 33 having triangular concaves and convexes are formed. The unevenness portions 33 are made into symmetrical shape with respect to the center line 35.

As shown in FIGS. 6 and 8, the unevenness portions 33 are continuously formed along the two sides in the length direction of the damper plate 30 on the top end of each of the peripheral ribs 34A-34B. Here, FIG. 9A shows the side sectional view in which the damper plate 30 is sectioned at the bottom of a concave portion in the unevenness portion 33 where the width of the outer side surface of each of the peripheral ribs 34A-34B becomes the minimum. FIG. 9B shows the side sectional view in which the damper plate 30 is sectioned at the top of a convex portion where the width of the outer side surface of each of the peripheral ribs 34A-34B becomes the maximum width r1.

Here, as shown in FIGS. 9A and 9B, the inner surface of each of the peripheral ribs 34A-34B is substantially normal to the surface of the flat plate portion 36 and the peripheral end portion of the damper plate 30 has substantially T-shape in a sectional view with the peripheral ribs 34A and 34B formed thereon. As shown in FIGS. 9A and 9B, the top surface of each of the peripheral ribs 34A-34B (which will be referred to as “unevenness surface” hereinafter), on which the unevenness portion 33 is formed, is made substantially parallel with the inner surface of the ribs.

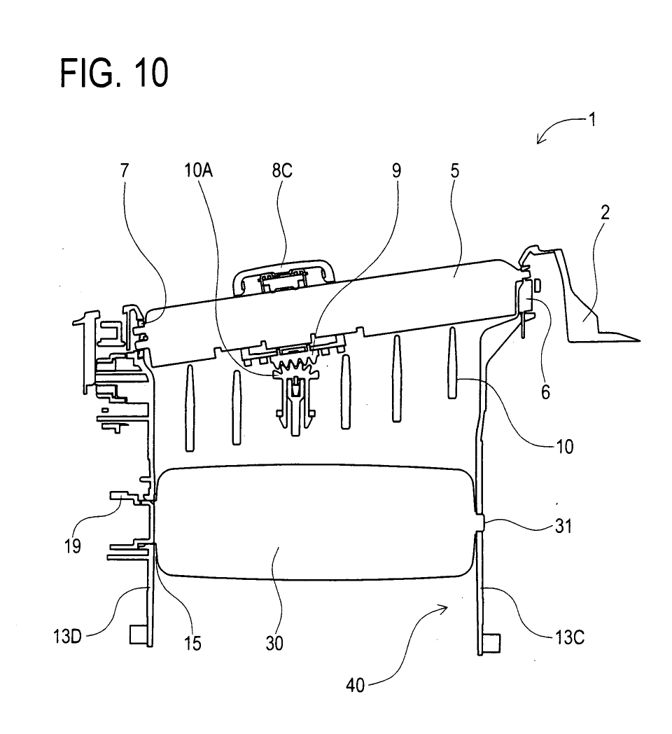

Next, opening/closing operation of the ventilation path 40 will be described in detail according to FIGS. 10 to 13.

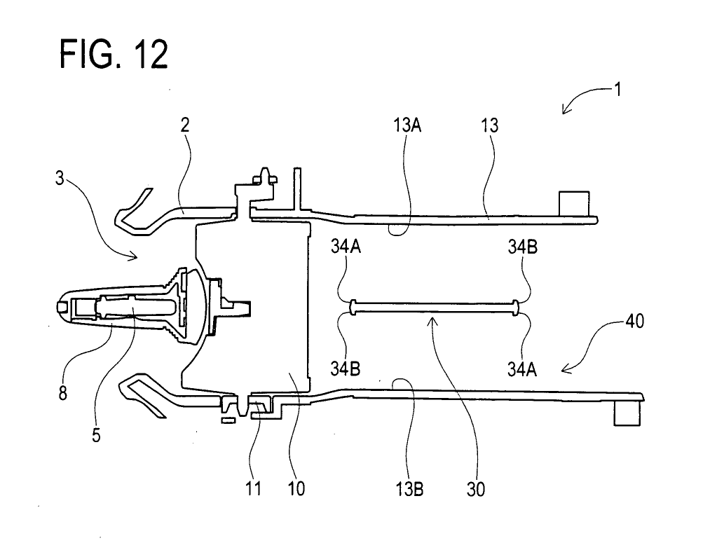

FIGS. 10 to 12 show a state that the damper plate 30 opens the ventilation path 40. As shown in FIGS. 10 and 12, the ventilation path 40 is surrounded by the upper wall surface 13A of the retainer, the lower wall surface 13B of the retainer (see FIG. 12) and the right wall surface 13C of the retainer, the left wall surface 13D of the retainer (see FIG. 13). As shown in FIG. 10, the damper plate 30 is rotatably supported within the ventilation path 40 in a state where the rotation shaft 31 is rotatably supported in a shaft hole formed on the right wall surface 13C of the retainer and the grasped portion 32 is grasped by the bifurcate portion 21 of the grasping member 19 which is inserted in the insertion hole 15 formed in the left wall surface 13D of the retainer. The rotation shaft 31 of the damper plate 30 is arranged in a direction substantially normal to the ventilation direction in the ventilation path 40. Even the two sides along the width direction of the peripheral end portion in the damper plate 30 except for the rotation shaft 31 and the grasped portion 32 can be smoothly rotated without contacting with the right and left wall surfaces 13C, 13D of the retainer.

As shown in FIG. 11, in the state that the ventilation path 40 is open, the flat plate portion 36 of the damper plate 30 is arranged so that the flat plate portion 36 becomes horizontal (parallel with the ventilation direction as shown in FIG. 12) and the rotation shaft 31 of the damper plate 30 is arranged on a same horizontal flat plane with the rotation shaft of the front fin 5. Therefore, a pressure loss due to the damper plate 30 can be suppressed to the minimum when the air flows within the ventilation path 40.

As shown in FIG. 12, the damper plate 30 positioned at the open state of the ventilation path 40 is rotated approximately 80 degrees in the clockwise direction in the right side view by rotation operation of the dial knob 17 toward the lower direction. With this, as shown in FIG. 13, the outer surface of the lower peripheral rib 34B becomes parallel with the lower wall surface 13B of the retainer with a narrow clearance r2 therebetween. Similarly, the outer surface of the upper peripheral rib 34A becomes parallel with the upper wall surface 13A of the retainer with the same narrow clearance r2 therebetween.

Here, as mentioned above, the peripheral ribs 34A, 34A of the retainer are respectively raised in different directions with respect to the center line 35 and the angle formed between each outer surface of the peripheral ribs 34A and 34B and the center line 35 becomes an acute angle (80 degrees in the embodiment). Therefore, even if the damper plate 30 is rotated to a position where the damper plate 30 closes the ventilation path 40, the peripheral ribs 34B, 34B do not interfere with the upper and lower wall surfaces 13A, 13B of the retainer.

Next will be described the effect of the peripheral ribs 34A, 34A when the ventilation path 40 is closed, according to FIG. 13. When both the upper peripheral rib 34A and the upper wall surface 13A of the retainer become parallel with each other with the narrow clearance r2 therebetween and both the lower peripheral rib 34A and the lower wall surface 13B of the retainer become parallel with each other with the narrow clearance therebetween, plane-like clearances with width r2 are respectively formed between the upper peripheral rib 34A and the upper wall surface 13A of the retainer and between the lower peripheral rib 34A and the lower wall surface 13B of the retainer (referred to as “parallel narrow clearance portions” hereinafter). This plane-like clearance provides large resistance against air flow and can shut out the air flow in spite of existence of the clearance with width r2. For example, as one mechanism, there can be put forward a shutout effect which can be realized when the width r2 becomes small, as explained by the Bernoulli's theorem. That is to say, when a flow path suddenly becomes narrow and static pressure decreases, in contrast dynamic pressure (flow velocity) largely increases. Thereby, pressure loss occurs in proportion to the dynamic pressure, and the larger the maximum width r1 of the outer surface in the peripheral rib 34A becomes, the larger the pressure loss becomes. As another mechanism, it can be put forward that vortex of turbulent flow is produced on the outer surfaces of the peripheral ribs 34A, 34A and the upper and lower wall surfaces 13A, 13B of the retainer facing to the peripheral ribs 34A, 34A, respectively, thereby the width through which air flow can pass in the parallel narrow clearance portion becomes smaller than the width r2 of narrow clearance.

Since flow velocity of air on the upper and lower wall surfaces 13A, 13B of the retainer and the surface of the damper plate 30 is zero, such vortex of turbulent flow occurs by separation of air flow near each surface. Such separation of air flow is also called as “separation bubble.” Occurrence of the flow separation is explained to relate to an entrance shape of each parallel narrow clearance. Describing according to the example shown in FIG. 13, the angle formed by the unevenness plane and the outer surface of the upper peripheral rib 34A is an obtuse angle, but is closer to ninety degrees. Thus, in the upper portions of the parallel narrow clearance portions, the flow separation is comparatively easy to occur. On the contrary, in the lower portion of the parallel narrow clearance portions, the outer surface of the peripheral rib 34B continues to the outer surface of the peripheral rib 34A at the opposite side of air flow direction and is gradually inclined to continue to the peripheral rib 34A. Thus, flow separation is comparatively hard to occur. However, in spite of the above situation, the embodiments described hereinafter indicate that the shutout effect against air flow can be sufficiently obtained by the peripheral rib 34 having the sectional T-shape.

Next, the effect of the unevenness portion 33 in the damper plate 30 (see FIGS. 6 and 8) will be described. As mentioned above, when the damper plate 30 closes the ventilation path 40 as shown in FIG. 13, air is scarcely passes through the parallel narrow clearance portions due to the shutout effect of the peripheral ribs 34A, 34A. However, when air partially passes through, flow velocity of such air is very fast. Therefore, two-dimensional vortex having high energy occurs, thereby allophone is likely to occur. However, as shown in FIG. 13, since the unevenness portion 33 is formed on each top of the upper peripheral rib 34A and the lower peripheral rib 34B, three-dimensional vortex crossing the vortex filament of the two-dimensional vortex is produced against the two-dimensional vortex by the unevenness portion 33 and the two-dimensional vortex is suppressed, thereby allophone can be suppressed. Here, by using the triangle unevenness portion 33 of the damper plate 30, the three-dimensional vortex becomes more complex than in the case that the rectangular unevenness portion 33 is used, for example, as in the fourth embodiment. Accordingly, the effect to suppress occurrence of the two-dimensional vortex becomes very high through the triangle unevenness portion 33.

Further, the effect by the peripheral ribs 34B, 34B will be described. As mentioned above, since the peripheral ribs 343, 34B are formed in the symmetry shape with the peripheral ribs 34A, 34A with respect to the center line 35, the damper plate 30 can be utilized in a register which has the symmetrical relation with the register 1 (register symmetrical with the register shown in FIG. 1, in which the dial 16 is arranged on the right side) in a reversed manner. In such a register, when the dial 16 is pressed down, the peripheral ribs 34B, 343 respectively become parallel with the upper and lower wall surfaces 13A, 13B of the retainer with the narrow clearance r2 therebetween. Therefore, sealing property of the ventilation path 40 can be obtained, similar to the peripheral ribs 34A, 34A in the register 1.

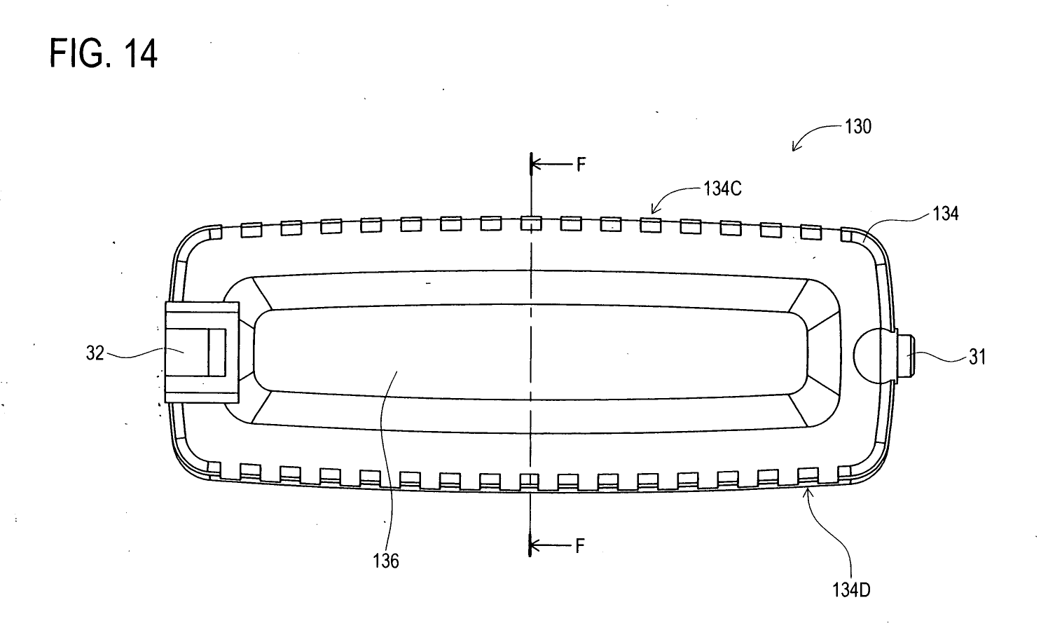

Next, according to FIGS. 14 to 19, the damper plate 130 of the second embodiment will be described. Hereinafter, in the second embodiments to the fourth embodiment, the construction which is the same as or corresponding to that of the first embodiment will be referred to by the same signs in the first embodiment and explanation thereof will omitted.

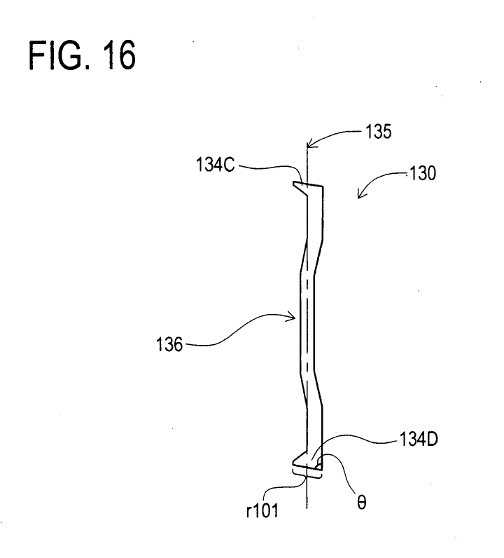

The damper plate 130 in the second embodiment has the different peripheral ribs from the peripheral ribs of the damper plate 30 in the first embodiment. As shown in FIGS. 14 to 16, the peripheral ribs 134 are raised on the same side of the damper plate 130 with respect to the central section (see the center line 135 in FIG. 16) which passes the center of the rotation shaft 31 and is normal to the thickness direction of the damper plate 130, along all periphery except for the rotation shaft 31 and the grasped portion 32 in the peripheral end portion of the damper plate 130. The central portion of the plate portion 136 except for the rotation shaft 31, the grasped portion 32 and the peripheral ribs 134 in the damper plate 130 is protruded to the same side as the top end of the peripheral ribs 134 is protruded. Based on this construction, eccentricity of the center of gravity in the damper plate 130 which may occur due to the shape of the peripheral ribs 134 can be corrected.

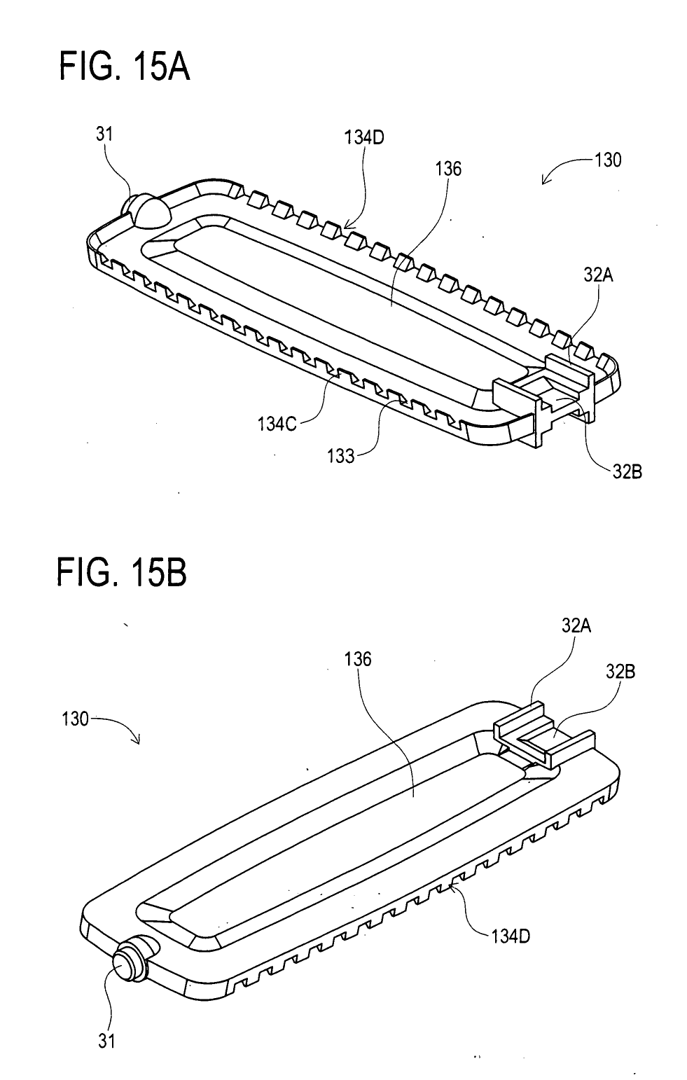

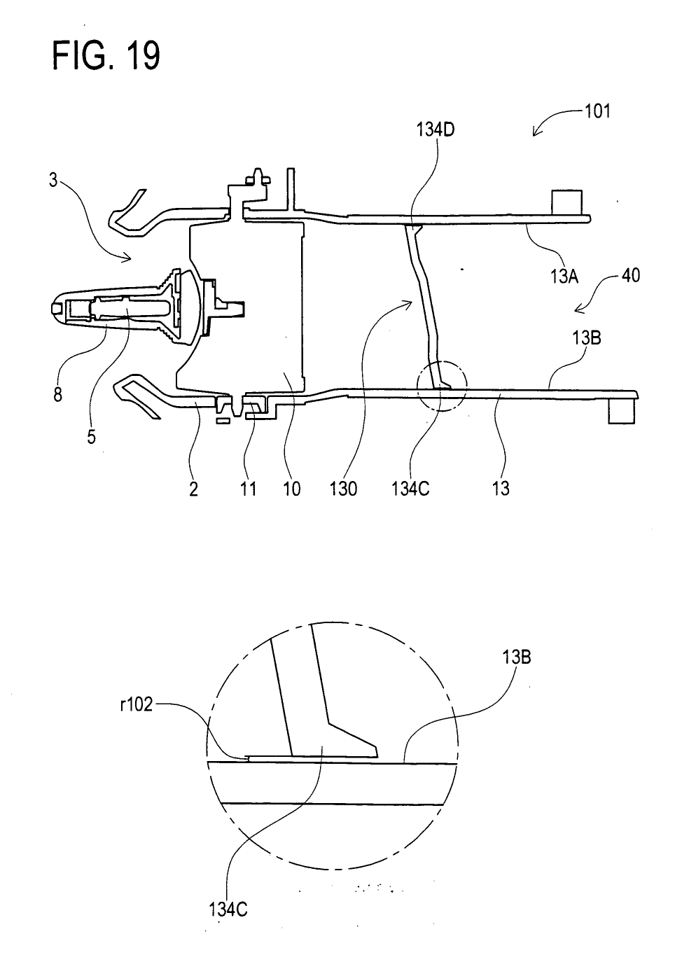

As shown in FIGS. 14 and 15, the peripheral ribs 134 are constructed with a peripheral rib 134C formed along a half periphery between the rotation shaft 31 and the grasped portion 32 and a peripheral rib 134D formed along the remaining half periphery. Each outer surface of the peripheral ribs 134C and 134D is substantially normal to the surface of the plate portion 136 in the width direction of the damper plate 130. However, as shown in FIG. 16, the angle θ formed by the outer surface of the peripheral rib 134D and the plate portion 136 becomes an acute angle and the angle formed by the outer surface of the peripheral rib 134C and the plat portion 136 becomes an obtuse angle which is the supplement of the angle θ. The angle θ is substantially equal with the acute angle (in the embodiment, 80 degrees) formed by the plate portion 136 of the damper plate 130 and the upper wall surface 13A of retainer and the lower wall surface 13B of the retainer, respectively, in the state that the damper plate 30 closes the ventilation path 40 (see FIG. 19).

As shown in FIGS. 15A, 15B and 16, the top ends of the peripheral ribs 134C and 134D are formed at an acute angle in the side view thereof. As shown in FIGS. 15A and 15B, in the second embodiment, cutout portions 133 are formed each in a rectangular shape with a predetermined distance therebetween in each of the peripheral ribs 134C, 134D. Thereby, each of the peripheral ribs 134C, 134D has the unevenness shape. This unevenness shape of the peripheral ribs 134C, 134D serves as a measure to prevent allophone. The cutout portions 133 are formed on the peripheral ribs 134C, 134D along the length direction of the peripheral portion in the damper plate 130.

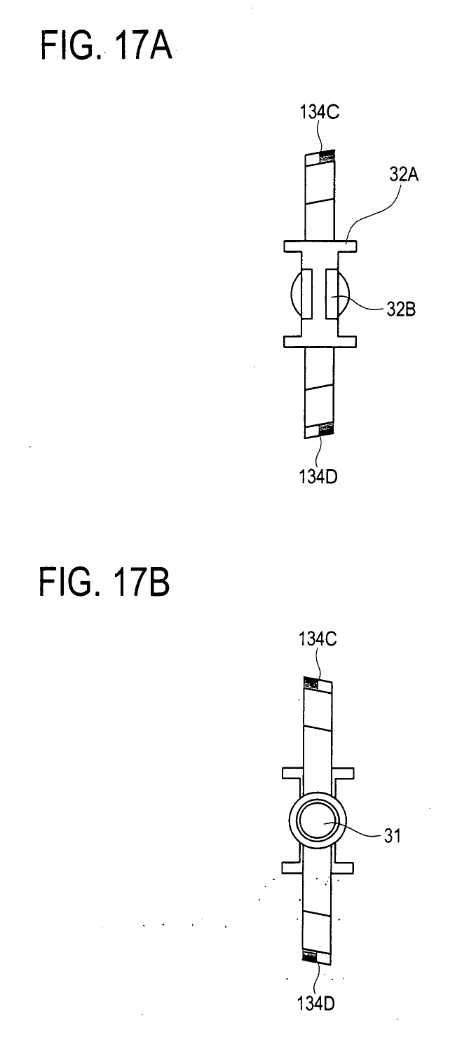

As shown in FIG. 16, each outer surface of the peripheral ribs 134C, 134D has the same width r101 and each top end thereof is formed in a triangle shape with an acute angle in the sectional side view. The peripheral ribs 134, as shown in FIGS. 16 and 17, are raised only on one side of the damper plate 130, thus the width r101 can be designed so as to become larger than that of the peripheral ribs in the first embodiment (in FIG. 16, the width r101 becomes twice the thickness of the plate portion 136).

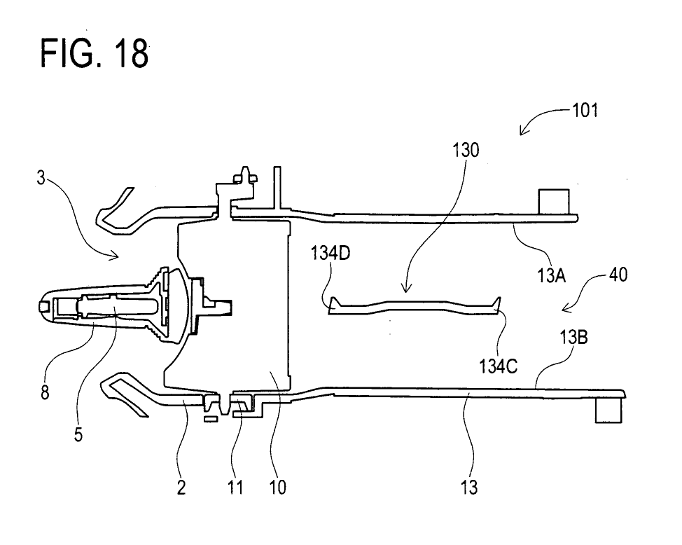

Based on FIGS. 18 and 19, there will be described opening/closing operation of the ventilation path 40 by the damper plate 130 according to the second embodiment. The register 101 of the second embodiment is realized by changing the damper plate 30 of the register 1 in the first embodiment to the damper plate 130.

Similar to the first embodiment, the damper plate 130 positioned parallel with the ventilation direction as shown in FIG. 18 is rotated (in the embodiment, approximately 80 degrees) in the clockwise direction in the right side view by pressing the dial knob 17 downward, thereby the damper plate 130 is rotated to the position to close the ventilation path 40 as shown in FIG. 19. At that time, the outer surface of the peripheral rib 134D becomes parallel with the upper wall surface 13A of the retainer with a narrow clearance r102 therebetween and the outer surface of the peripheral rib 134C becomes parallel with the lower wall surface 13B of the retainer with the narrow clearance r102. Thereby, the plane-like clearance is formed in each of the parallel narrow clearance portions.

Here, each top portion of the peripheral ribs 134C, 134D faces in the direction of incoming air. Therefore, when air in the ventilation path 40 enters into each of the parallel narrow clearance portions, air collides against surfaces of the top portions of the peripheral ribs 134C, 134D. Thereby, flow separation is more likely to occur and air flow is hard to pass through each of the parallel narrow clearance portions. Especially, since the top portions of the peripheral ribs 134C, 134D except for the cutout portions 133 are formed at the acute angle, flow separation easily occurs at the surfaces of such acute angle portions.

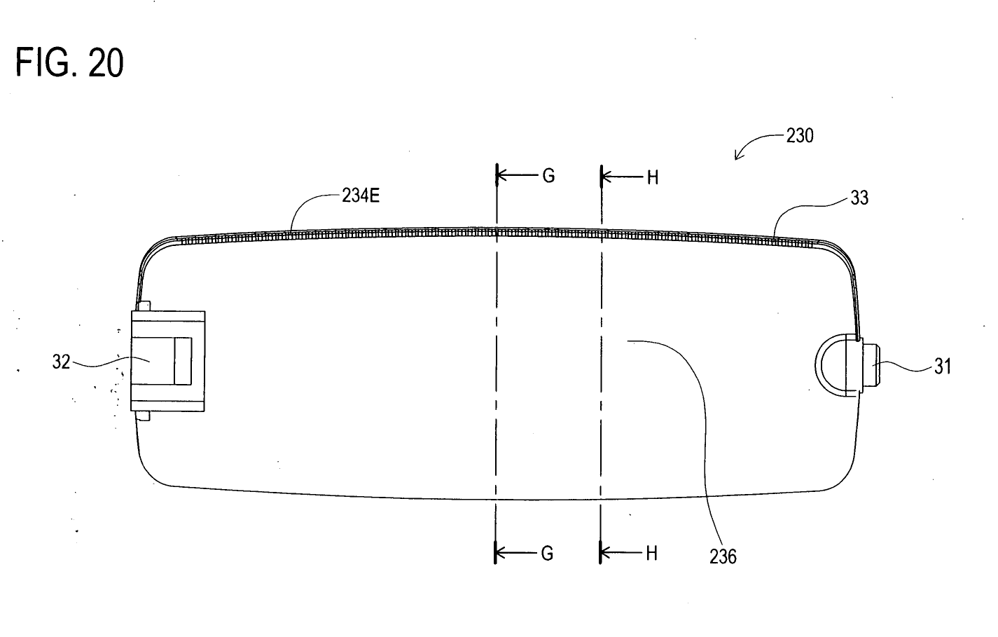

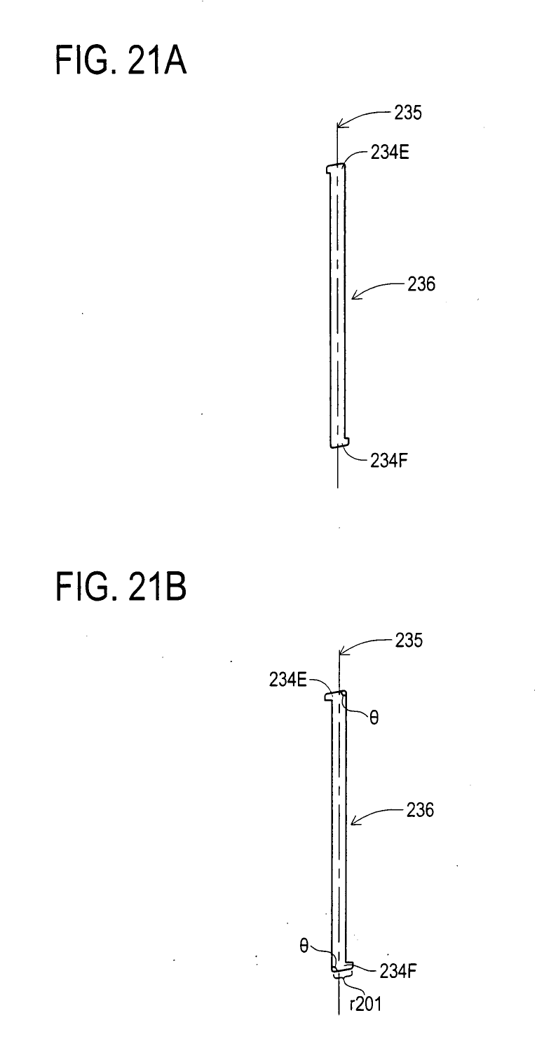

Next, based on FIGS. 20 to 24, the damper plate 230 of the third embodiment will be described. As shown in FIGS. 20 to 22, in the damper plate 230 of the third embodiment, the peripheral ribs 234E, 234F, each of which is formed along each half periphery of the peripheral end portion of the damper plate 230, are protruded from each of the opposite sides with respect to the center section (in FIG. 21, refer to the center line 235) intersecting at right angles in the thickness direction of the damper plate 230. The angle θ formed by each outer surface of the peripheral ribs 234E, 234F and flat plate portion 236 is equal with the acute angle formed by the damper plate 230 and the upper wall surface 13A of the retainer, the lower wall surface 13B of the retainer, when the ventilation path 40 is closed. Therefore, the damper plate 230 in the third embodiment can be regarded as a modification of the damper plate 30 in which the peripheral ribs 34B, 34B are removed.

At each of the top portions of the peripheral ribs 234E, 234F, similar to the peripheral ribs in the first embodiment, the unevenness portion 33 with the triangle shapes are formed. FIG. 21A is a sectional view obtained by sectioning the damper plate 230 at the bottom portion of the unevenness portion 33, and the minimum width of the outer surface in each of the peripheral ribs 234E, 234F is indicated. FIG. 21B is a sectional view obtained by sectioning the damper plate 230 at the protrusion having the triangle shape in the unevenness portion 33, and the maximum width of the outer surface in each of the peripheral ribs 234E, 234F is indicated.

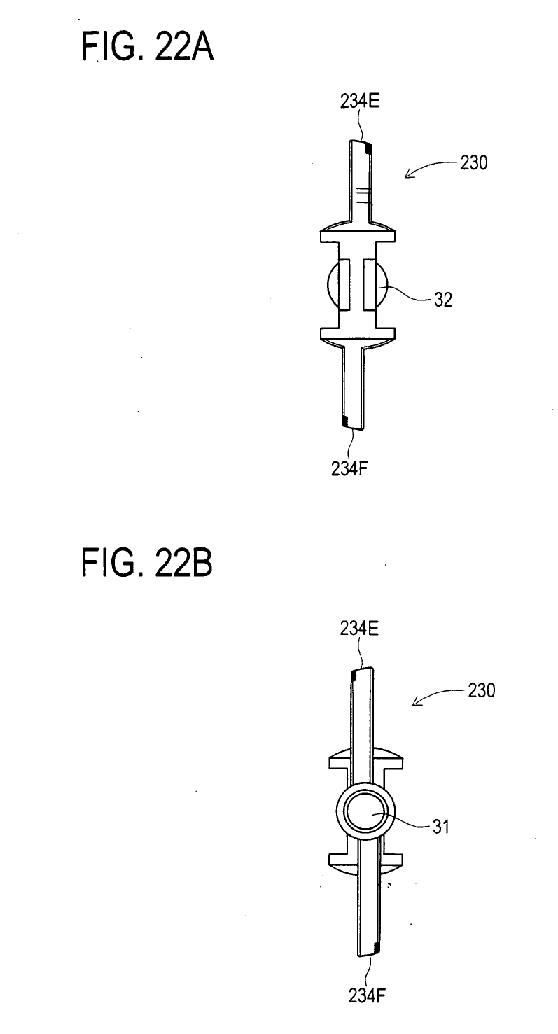

As shown in FIGS. 21 and 22, in the third embodiment, the outer surface of each of the peripheral ribs 234E, 234F extends to the surface of the plate portion 236, therefore the maximum width r201 can be designed to be large.

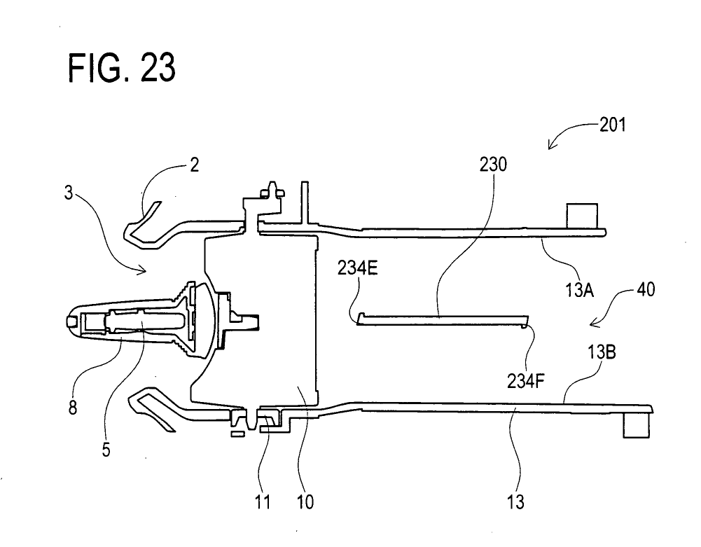

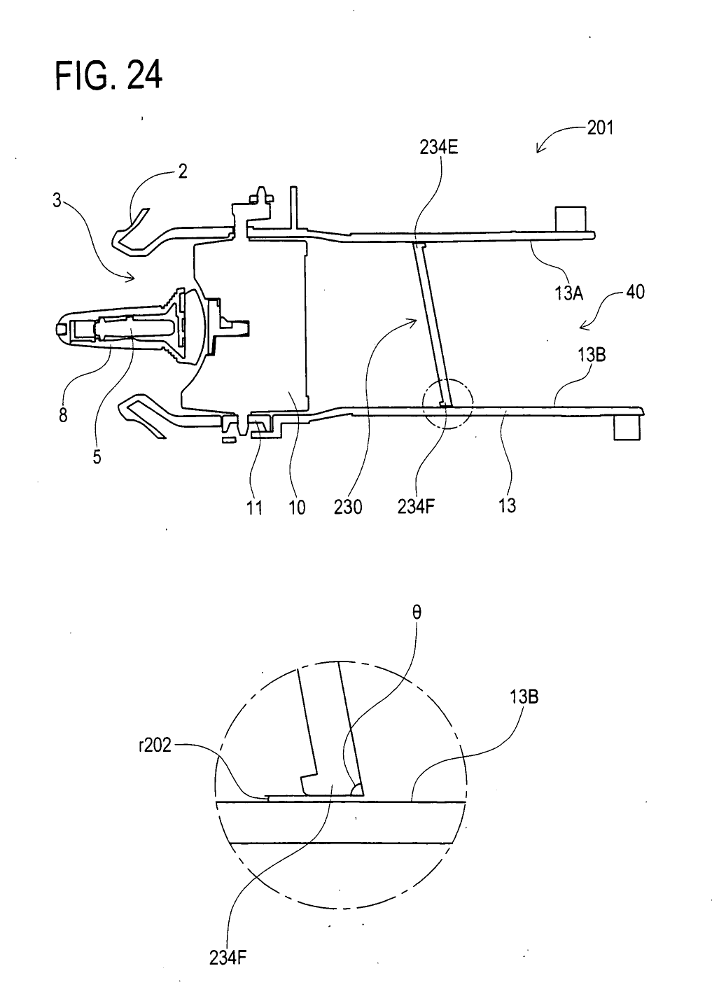

Based on FIGS. 23 and 24, there will be described the opening/closing operation of the ventilation path 40 by the damper plate 230 in the third embodiment. The register 201 of the third embodiment is realized by changing the damper plate 30 of the register 1 in the first embodiment to the damper plate 230. As shown in FIG. 23, the damper plate 230 positioned parallel with the ventilation direction is rotated approximately 80 degrees in the clockwise direction in the right side view by pressing the dial knob 17 downward (refer FIG. 1), thereby the damper plate 230 becomes the state shown in FIG. 24, where the ventilation path 40 is closed by the damper plate 230. The upper peripheral rib 234E and the upper wall surface 13A of the retainer, the lower peripheral rib 234F and the lower wall surface 13B of the retainer respectively become parallel with the narrow clearance r202 therebetween, respectively. Thereby, the plane-like clearance is formed in each of the parallel narrow clearance portions.

As shown in FIG. 24, in the upper peripheral rib 234E facing to the direction of incoming air, the angle formed by the outer surface and the unevenness surface becomes substantially right angle, therefore flow separation is comparatively likely to occur and air flow is hard to pass in the upper parallel narrow clearance portion. Also in the lower parallel narrow clearance portion, the outer surface of the peripheral rib 234F and the surface of the plate portion 36 forms an acute angle without round shape. Thereby, flow separation is likely to occur and air flow is hard to pass.

Here, the top portion of the peripheral rib 234F having the unevenness portion 33 faces to the direction of incoming air, therefore allophone is easy to occur in the lower parallel narrow clearance portion. As a measure to prevent the above problem, the unevenness shape may be continuously formed at the lower edge portion of the plate portion 236 facing to air flow when in a closed state.

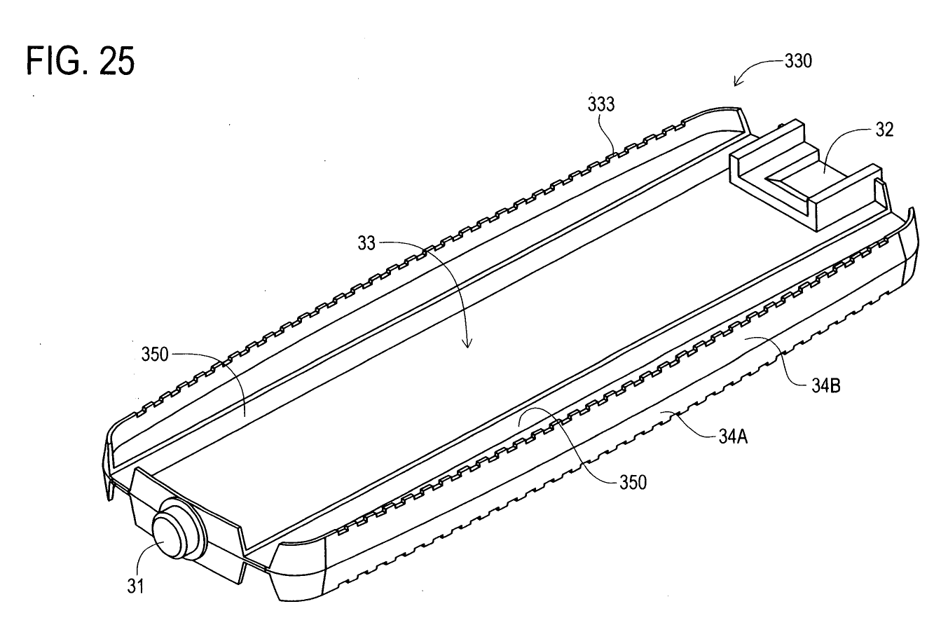

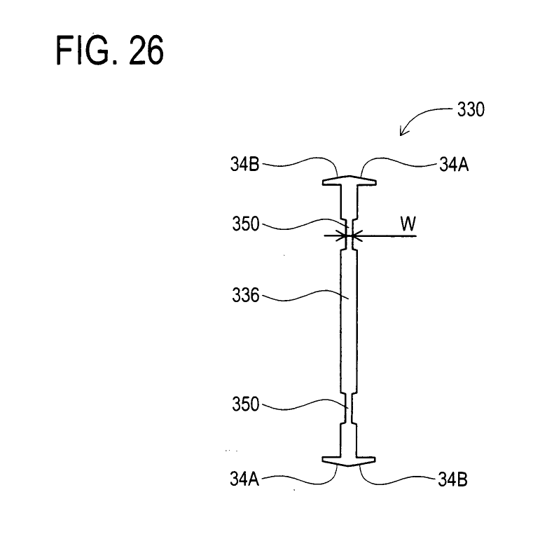

Next, the damper plate 330 of the fourth embodiment will be described with reference to FIGS. 25 and 26. The damper plate 330 has almost the same construction of the damper plate 30 in the first embodiment, but is different from the damper plate 30 at the point that the thinner portions 350, 350 are formed in the plate portion 336. The thinner portions 350, 350 each have a belt-like shape over the length direction of the damper plate 330 and are formed at two portions between the two peripheral ends along the length direction of the damper plate 330, and the rotation shaft 31 and the grasped portion 32, respectively. In FIG. 25, each of the peripheral ribs 34A, 34B is not formed at a portion connected with the thinner portion 350. As shown in FIG. 26, the thickness w of the thinner portion 350 is made equal to or less than ½ of the thickness of the central plate portion 336, thereby the thinner portions 350 can give enough bending ability to the damper plate 330.

When the mentioned damper plate 330 is arranged in the register 1 of the first embodiment instead of the damper plate 30, following effects can be obtained. Namely, in the damper plate 330, since the peripheral ribs 334A-334B are formed along the peripheral ends, the peripheral portions (for example, top portion of the peripheral rib 334A) of the damper plate 330 may have contact with the upper and lower wall surfaces 13A, 13B of the retainer due to variations caused during production process while the damper plate 330 is rotated from the open state to the close state of the ventilation path 40. This kind of variations may occur, for example, due to heat shrinkage during production of the register 1. However, as the thinner portions 5 are provided, even if the peripheral end of the damper plate 330 and the retainer upper and lower wall surfaces 51A, 51B interfere with each other right before the ventilation path 40 is closed, the damper plate 330 is allowed to bend. Therefore, the damper plate 330 can be rotated to the closed state.

### EXPERIMENTS

Hereafter, the present invention will be further examined by experiments. Here, the present invention is never limited to the experiments.

The experiment described below has been conducted using the register 1 of the first embodiment, in which the damper plate 30 was arranged. In the experiment, value of the maximum width r1 of the outer surface in each of the peripheral ribs 34A, 34B and value of the clearance width r2 of the parallel narrow clearance portion when the ventilation path 40 was closed were variously changed, and it has been examined whether or not enough sealing property could be obtained when the ventilation path 40 was closed.

Concretely, the maximum width r1 was changed in 10 stages by 1 mm within a range of 1 though 10 mm, and the clearance width r2 was changed in 11 stages by 0.1 mm within a range of 0 through 1 mm. As a result, 110 combinations of the value r1 and the value r2 were examined.

Hereinafter, the experimental system will be described. In the experimental system, one end of a cylindrical pipe (having length of approximately 30 cm) was connected to one side of a chamber (having a cubic shape with a size of 1.5 m×1.5 m×1.5 m), and the other end of the cylindrical pipe was connected to a blower. An ultrasonic flowmeter was arranged in the middle of the cylindrical pipe. In the chamber, to an opposite side against the one side where the cylindrical pipe was provided, a square blowout hole was opened. To the square blowout hole, a base end portion (having the same size of the blowout hole) of a nozzle having a quadrangular pyramid shape was connected. The top end of the nozzle was formed in a rectangular shape which was the same as the shape of the rear end peripheral portion of the retainer 13, and such top end of the nozzle was connected to the rear end peripheral portion of the retainer of the register 1. The reason why the chamber was arranged before air was blown into the ventilation path 40 of the retainer 13 of the register 1 from the blower as mentioned was to remove influence due to changes in outer circumstance. As energy of air flown from the blower was changed from dynamic pressure to static pressure, air whose flow velocity was scarcely fluctuated was flown into the nozzle and the blowout hole.

In the register 1, as shown in FIG. 12, the ventilation path 40 was opened by positioning the damper plate 30 parallel with the ventilation direction. In this state, air was blown from the blower, and after the elapse of a predetermined period of time, it was confirmed by the ultrasonic flowmeter that quantity of air blow became constant (blow quantity A). Continuously, the dial knob 17 was operated and the damper plate 30 was closed, thereby the damper plate 30 reached the state shown in FIG. 13. Thereafter, blow quantity B was measured. Here, when the quantity B fell below 10% of the quantity A, it was determined that the sealing property was sufficient (indicated by ◯ in table 1). However, when the quantity B exceeds 10% of the quantity A, it was determined that the sealing property was insufficient (indicated by x in table 1).

TABLE 1

| | | | | | | | | | | | |
|---|---|---|---|---|---|---|---|---|---|---|---|
| CLEARANCE | 1 | X | X | X | X | X | X | X | X | X | X |
| WIDTH | 0.9 | X | X | X | X | X | X | X | X | X | ◯ |
| r2 (mm) | 0.8 | X | X | X | X | X | X | X | ◯ | ◯ | ◯ |
| | 0.7 | X | X | X | X | X | ◯ | ◯ | ◯ | ◯ | ◯ |
| | 0.6 | X | X | X | X | ◯ | ◯ | ◯ | ◯ | ◯ | ◯ |
| | 0.5 | X | X | X | ◯ | ◯ | ◯ | ◯ | ◯ | ◯ | ◯ |
| | 0.4 | X | X | ◯ | ◯ | ◯ | ◯ | ◯ | ◯ | ◯ | ◯ |
| | 0.3 | X | ◯ | ◯ | ◯ | ◯ | ◯ | ◯ | ◯ | ◯ | ◯ |
| | 0.2 | ◯ | ◯ | ◯ | ◯ | ◯ | ◯ | ◯ | ◯ | ◯ | ◯ |
| | 0.1 | ◯ | ◯ | ◯ | ◯ | ◯ | ◯ | ◯ | ◯ | ◯ | ◯ |
| | 0 | ◯ | ◯ | ◯ | ◯ | ◯ | ◯ | ◯ | ◯ | ◯ | ◯ |
| | | 1 | 2 | 3 | 4 | 5 | 6 | 7 | 8 | 9 | 10 |

MAXIMUM WIDTH r1 (mm)

Experimental results are listed in table 1. It has been confirmed that the sealing property of the ventilation path 40 can be sufficiently obtained within value ranges which indicate ◯ in table 1.

As shown in table 1, the larger the maximum width r1 of the peripheral ribs 34A-34B in the damper plate 30 becomes, the larger shutout effect of the ventilation path 40 becomes. It has been confirmed that even if the clearance width r2 becomes larger to a certain extent, the sealing property of the ventilation path 40 can be obtained when the ventilation path 40 is closed.

On the other hand, since the peripheral ribs 34A, 343 face in the ventilation direction when the ventilation path 40 is opened (see FIG. 11), pressure loss in the open state of the ventilation path 40 caused by the peripheral ribs 34 becomes larger as the value r1 becomes larger. When the value r1 is excessively large, interference of the damper plate 30 and the other members is likely to occur. Accordingly, it is preferable that the value r2 lies in a range with which the value r1 can be made small to a predetermined extent.

With reference to table 1, in a case the clearance width r2 is 1 mm or more, the sealing property of the ventilation path 40 cannot be obtained with the value r1 being within a range of 1 through 10 mm. In contrast, in a case the clearance width r2 is 0.9 mm or less, the sealing property of the ventilation path 40 can be surely obtained with the value r1 within a range of 10 mm or more, therefore this case is preferable. Further, in a case the value r2 is 0.7 mm or less, the sealing property can be surely obtained with the value r1 within a range of 6 mm or more, therefore this case is more preferable. Further, in a case the value r2 is 0.3 mm or less, the sealing property of the ventilation path 40 can be surely obtained with the value r1 within a range of 2 mm or more, therefore this case is the most preferable. However, for example, in table 1, in a case the value r2 is 0.2 mm and the value r1 is 1 mm, ◯ is indicated. Accordingly, if the value r2 is set 0.3 mm or less, it is not necessary that the value r1 is always set 2 mm or more.

As mentioned above in detail, in the first (or the second, the third or the fourth) embodiment, when the damper plate 30 (or 130, 230, 330) is rotated to the position where the ventilation path 40 is closed, the outer surface of the upper peripheral rib 34A (or 134D, 234E), which is formed at two sides of the damper plate along the direction of the rotation shaft 31, becomes parallel with the upper wall surface 13A of the retainer with the narrow clearance therebetween, and the outer surface of the lower peripheral rib 34B (or 134C, 234F) becomes parallel with the lower wall surface 13B of the retainer, respectively, forming plane-like clearances. These plane-like clearances provide great resistance for air flowing in the ventilation path 40. As a result, similar to the conventional register using the damper seal, air flow can be stopped using the plane-like clearances. Therefore, the sealing property of the ventilation path 40 can be surely obtained without any contact of the damper plate with the inner walls of the retainer 13 when the ventilation path 40 is closed, even if the damper seal is not provided to the damper plate 30 (or 130, 230, 330) and ribs are not formed in the retainer 13. Thus, there can be solved such problems as allophone occurs and the damper is not smoothly rotated, and cost of producing the damper can be enormously reduced.

In the damper plate 30 of the first embodiment, the peripheral ribs 34B, 34B having a shape symmetrical with the peripheral ribs 34A, 34A are formed at the two sides along the extending direction of the rotation shaft 31 with respect to the center section (center line 35) of the damper plate, symmetrical with respect to the center section passing the center of the rotation shaft 31 and being normal to the thickness direction of the damper plate. Therefore, in a case the damper plate 30 is reversed and arranged in a register having a shape symmetrical with the register 1, the sealing property of the ventilation path 40 can be surely obtained by the function of the peripheral ribs 34B, 34B, similar to the case of the register 1. Thus, with the damper plate 30 in the first embodiment, one kind of damper plate 30 can be utilized in two kinds of registers each of which has a shape symmetrical with each other, and as a result, cost of producing the die, etc. can be further reduced.

In the damper plate 30 of the first embodiment, the peripheral ribs 34A, 34A formed at two sides along the extending direction of the rotation shaft 31 are respectively formed at the sides opposite with respect to the center section (center line 35), and the outer surface of the peripheral rib 34A and the center section (center line 35) forms an acute angle. Therefore, the peripheral ribs 34B, 34B symmetrical with the peripheral ribs 34A, 34A are also respectively formed at the opposite sides with respect to the center section, so that the outer surface of the peripheral rib 34B and the center section form an acute angle. Thus, even if the damper plate 30 closes the ventilation path 40 in the state that the damper plate 30 is inclined toward the upper wall surface 13A of the retainer and the lower wall surface 13B of the retainer, the peripheral ribs 34B, 34B can be formed so as not to prevent rotation of the damper plate 30.

In the damper plate 130 of the second embodiment, the peripheral ribs 134C, 134D formed at each of two sides along the extending direction of the rotation shaft respectively face to the direction of incoming air when the damper plate 130 is positioned at the position to close the ventilation path 40. Therefore, the entrance shapes of the parallel narrow clearance portions formed between the peripheral ribs 134C, 134D and the upper wall surface 13A of the retainer and the lower wall surface 13B of the retainer become the shape more difficult for air to flow in the ventilation path 40, thus the sealing property of the ventilation path 40 by the damper plate 30 can be further effectively improved.

In the fourth embodiment, the thinner portions 350 are formed along the peripheral ribs 34A, 34A on the plate portion 336 of the damper plate 330. Therefore, even if the retainer inner walls and peripheral portions of the damper plate 330 interfere with each other while the damper plate 330 is rotated and the ventilation path 40 is closed, impact caused between the damper plate 330 and the retainer inner wall can be absorbed by the thinner portions 350, thus the damper plate 330 can be rotated until the ventilation path 40 is closed.

In the first (or the second and the third) embodiment, the peripheral rib 34A, 34A (or 134C, 134D, 234 E, 234F) is formed around all periphery of the damper plate 30 (or 130, 230) except for the rotation shaft 31 and the grasped portion 32. Therefore, the outer surfaces of the peripheral ribs 34A, 34A (or 134C, 134D, 234E, 234F) also face to the right and left wall surfaces 13C, 13D of the retainer supporting the rotation shaft 31 of the damper plate 30 (or 130, 230) with narrow clearances therebetween, respectively. Thereby, the sealing property when the ventilation path 40 is closed can be further improved.

Here, the present invention is not limited to the above embodiments, thus it will be understood that various improvements and modifications can be made within the scope of the present invention. For example, the thinner portions 350 may be formed in the damper plate of the second embodiment and the third embodiment. Instead of the cutout portion 133 of the peripheral rib in the second embodiment, the unevenness portion 33 having the triangle shape continuously formed on the top of the peripheral rib in the first embodiment may be formed. In that case, it is more effective if the top of the peripheral rib is formed into an acute angle at the convex portions in the unevenness portion.

In each of the embodiments, although the damper plate closes the ventilation path in a state that the damper plate is inclined toward the front side, the present invention is not limited to this construction. The present invention includes the construction where the damper plate closes the ventilation path in a state that the damper plate is inclined toward the rear side through a design change of the dial, etc. Further, the present invention includes the construction where the damper plate closes the ventilation path in a state that the damper plate is rotated 90 degrees from the parallel state and closes the ventilation path in a state that the damper plate becomes normal to the retainer upper and lower walls. In this case, the angle θ formed by the outer surface of each peripheral rib and plate portion becomes approximately 90 degrees.

Although in each embodiment, in a case that the ventilation path is closed, the widths of two parallel narrow clearance portions become the same value, it is needless to say that it is permissible that such widths may be slightly different.

In the third embodiment, although the angles formed between the outer surface of peripheral ribs 234E, 234F and the surface of the plate portion becomes the same acute angle, the present invention includes a case that such an angle is designed to be the same obtuse angle.

1. A damper plate rotatably arranged in a ventilation path formed within a retainer of a register for air conditioning in a vehicle, the damper plate having a flat plate portion formed in a substantially rectangular shape and a rotation shaft, in which two sides among four sides forming a periphery of the flat plate portion are configured to approach near a pair of inner walls opposing each other in the retainer, thereby the damper plate closes the ventilation path,
wherein the damper plate has first peripheral ribs raised so as to form outer surfaces at least from the two sides of the periphery of the flat plate portion, and
wherein, when the damper plate is rotated to a position to close the ventilation path, the outer surfaces of the first peripheral ribs formed in the two sides respectively approach to the inner walls of the retainer and respectively become parallel with the inner walls while securing narrow clearances therebetween.

2. The damper plate according to claim 1, wherein a second peripheral rib is formed in each of the two sides, the second peripheral rib having a symmetrical shape with a first peripheral rib with respect to a center section of the damper plate, the center section representing a sectional plane passing a rotational center of the rotation shaft and perpendicular to a thickness direction of the damper plate.

3. The damper plate according to claim 2, wherein each of the first peripheral ribs in the two sides is raised from an opposite side of the flat plate portion with respect to the center section, and
wherein the outer surface of the first peripheral rib intersects the center section at an acute angle.

4. The damper plate according to claim 1, wherein each of the first peripheral ribs in the two sides faces to a direction of incoming air when the damper plate is rotated to the position to close the ventilation path.

5. The damper plate according to claim 1, wherein a thinner portion which is thinner than the flat plate portion is formed in the flat plate portion forming a main body of the damper plate, along the first peripheral rib.

6. The damper plate according to claim 1, wherein the damper plate has a grasped portion at one side opposite to a side where the rotation shaft is formed, and
wherein the first peripheral ribs are formed all around the periphery except for the rotation shaft and the grasped portion in the periphery of the damper plate.

7. A register for air conditioning in a vehicle in which the damper plate claimed in claim 1 is arranged.
